(19) United States
(12) Patent Application Publication
(10) Pub. No.: US 2017/0070085 A1
(43) Pub. Date: Mar. 9, 2017

(54) HYBRID STORAGE SYSTEM

(71) Applicant: ROBERT BOSCH GMBH, Stuttgart (DE)

(72) Inventors: Jingting Cher, Singapore (SG); Annika Carolin Kufner, Neunkirchen am Brand (DE); Falco Sengebusch, Singapore (SG); Sumedha Chouthe, Singapore (SG); Xingchi Wang, Singapore (SG); Yanlin Li, Shanghai (CN)

(21) Appl. No.: 15/123,033

(22) PCT Filed: Mar. 3, 2014
(86) PCT No.: PCT/IB2014/059392

§ 371 Date: Sep. 1, 2016

(51) Int. Cl. H02J 7/35; H02S 40/32; H02S 40/38; H02J 7/00

(52) U.S. Cl. CPC H02J 7/35; H02J 7/0045; H02S 40/32; H02J 7/007; H02S 40/38

(57) ABSTRACT

A hybrid battery-charging device with input terminals for connecting a current source, first battery connections for connecting a lead-acid battery and second battery connections for connecting a high-cycle chemical battery. A two-way DC/DC converter with first and second sets of terminals is connected with the second battery connections, and with the first battery connections. A charge and discharge control system of the charging device is operative to detect when an internal resistance of the lead-acid battery exceeds a predetermined resistance threshold, and to control the DC/DC converter, in response to the internal resistance of the lead-acid battery exceeding the predetermined resistance threshold, such that, in a discharge mode, the lead-acid battery and the high-cycle chemical battery are discharged in parallel during a parallel discharge phase.

### BACKGROUND INFORMATION

Historically, lead-acid batteries have been among the first rechargeable batteries. In 1859, the French physicist Gaston Plante developed the first practically useful prototype. Nowadays lead-acid batteries are produced in a variety of types according to specific requirements such as price, life expectancy, robustness against environmental conditions, charging or discharging capabilities, recycling properties and weight. Lead-acid batteries are grouped into valve regulated lead-acid batteries (VRLA), also known as sealed lead-acid batteries (SLA), and refillable or flooded lead-acid batteries. There are two primary types of VRLA, gel cells and absorptive glass mats (AGM). In gel cell batteries, the electrolyte is thickened by addition of silica dust while in AGM batteries a fibreglass mat that takes up the electrolyte is inserted between the battery plates.

Lead acid batteries have been used for years as the main storage medium in off-grid solar systems and in remote energy systems (RES) in general. The popularity of lead-acid batteries is mainly motivated by their low purchasing price. However, over the total lifetime of a RES, the lead-acid battery often becomes the main cost driver since it has to be changed every 1 to 3 years resulting in high costs for acquiring and changing several batteries. This relatively short lifetime, compared, for example, to lead (Pb) batteries in back-up systems, is due to the nature of remote energy applications. For example, in an off-grid solar system a battery is partly charged during daytime for several hours depending on the geographic location and on the weather and mainly discharged during night time, for example for running light bulbs, for running a TV set or other equipment and machinery. Due to these conditions, the lead-acid battery remains most of the time in a low state of charge (SOC) and it is rarely fully charged. These aspects affect the capacity of a lead-acid battery since they tend to increase the sulfation process in a lead-acid battery.

During a typical discharge cycle of a gel cell lead-acid battery, the voltage stays approximately constant and drops sharply towards the end of the discharging process. At the same time the interior resistance of the battery increases and rises sharply towards the end of the discharging cycle. Due to various factors, a lead-acid battery may have a high internal resistance even if it is not at the end of a discharge cycle.

For many applications, it is necessary to determine the state of charge (SOC) of the battery. In flooded lead batteries, the electrolyte concentration can be used for this purpose. In dry batteries, the SOC is determined, among others, by measuring the open-circuit voltage, the internal resistance, by inductive measurements using an external coil, by determining the battery resonance frequency or by evaluating the electrochemical noise of the battery.

Several mechanisms affect the life expectancy of a lead-acid battery. The anode is subject to grid corrosion, which is especially prominent for deep discharges, while the cathode is affected by sulphating and the electrolyte can be affected by water loss and acid stratification. In AGM batteries, the elasticity of the glass fibres decreases over time and the contact with the electrolyte deteriorates. In gel cell batteries, unavoidable water losses tend to thicken the electrolyte gel and this will eventually deteriorate the contact between the gel and the electrodes. Acid stratification mainly affects flooded lead-acid batteries and only to some extent the AGM batteries. Water loss affects the lifetime of gel cell batteries and is most pronounced when the battery is overcharged or is charged too fast.

Rechargeable lithium batteries are produced as lithium-ion and lithium polymer batteries. Lithium polymer batteries, which are also known as lithium-ion polymer batteries, have similar properties as lithium ion batteries but, different from lithium ion batteries, they do not contain a liquid electrolyte. Lithium batteries have a much higher energy density than lead-acid batteries and they can be discharged to a lower level. On the other hand, lithium batteries are sensitive against deep discharge and against overcharging and have a lower lifespan than other type of batteries. A deep discharge sets in when the battery voltage falls below about 2.5 Volt. Furthermore, lithium batteries with multiple cells connected in series require a cell balancing electronics.

During discharge of a lithium battery, the voltage falls off only slightly before the end of a discharge cycle is reached. The internal resistance, by contrast, decreases until about 60% of the capacity is reached and increases again when the battery is discharged further.

Various factors affect the lifespan of a lithium battery such as high temperatures, deep discharges, high charge or discharge currents and high charge voltages. While lead-acid batteries can last a long time if they are properly stored and recharged in regular intervals, lithium batteries age significantly during storage.

### SUMMARY

It is an object of the present invention to provide an improved hybrid storage system and improved methods for charging and discharging batteries of the hybrid storage system.

In accordance with the present invention, a hybrid battery-charging device with input terminals for connecting a photovoltaic panel or other current supply and output terminals for connecting a load.

First battery connections are provided for connecting a lead-acid battery and second battery connections are provided for connecting a high-cycle chemical battery. A two-way DC/DC converter is connected between the high-cycle chemical battery and the lead-acid battery such that a first set of terminals of the two-way DC/DC converter is connected with the second battery connections and a second set of terminals of the two-way DC/DC converter is connected with the first battery connections. An input to the output terminals is derived from the first battery connections in that the output terminal are connected to the first battery connections with or without further components in between.

A charge and discharge control system is connected to the two-way DC/DC converter by a control line. The charge and discharge control system comprises a first sensing input for sensing a state of charge of the lead-acid-battery and for sensing an internal resistance of the lead-acid battery a second sensing input for sensing a state of charge of the high-cycle chemical battery and a control output for controlling the two-way DC/DC converter and a controller unit.

The first sensing input may comprise one input port to detect state of charge and internal resistance or it may also comprise separate input ports for SoC and resistance detection.

The controller unit is operative to detect, by evaluating signals from the second sensing input, when an internal resistance of the lead-acid battery exceeds a predetermined resistance threshold. Furthermore, the controller unit is operative to control the two-way DC/DC converter, for example by controlling a cycle length of a switch of the two-way DC/DC converter in response to the internal resistance of the lead-acid battery exceeding the predetermined resistance threshold. The two-way DC/DC converter is controlled in such a way that during a discharging cycle of the lead-battery, the lead-acid battery and the high-cycle chemical battery are discharged in parallel, or, in other words, simultaneously, during a parallel discharge phase.

In particular, the predetermined internal resistance can be chosen such that it indicates a reduced functionality of the lead-acid battery. According to the present invention, the controller unit then chooses a discharge strategy that puts less stress on the lead-acid battery. The functionality of the computation is provided, among others, by suitable hardware and/or machine-readable instructions that are stored in a computer readable memory.

The sensing inputs are directly or indirectly connected to sensor at the lead-acid battery and at the high-cycle chemical battery. The sensing inputs can be indirectly connected in that further processing units such as a voltage monitoring chip may be connected in between a sensing input and a sensor at the battery. In the context of the present invention, a sensor also includes electronic components such as an external coil or a resonance circuit which are used as sensors to probe the battery. The sensing inputs may receive analogue signals or, if an A/D converter is connected in between the sensors and the sensing inputs, they may also receive digitized signals.

According to a further embodiment, the controller unit is operative to select a discharge strategy in response to input signals to the charge and discharge control system that it receives over the first and second sensing input. The discharge strategy comprises conditions for the start and the termination of the parallel discharge phase. Furthermore, the discharge strategy can be chosen such that the lead-acid battery and the high-cycle chemical battery are discharged simultaneously over a period of time, even if the power demand of a connected load is low, when an internal resistance of the lead-acid battery exceeds a predetermined value.

According to a further embodiment, the controller unit is operative to derive a first battery condition such as battery health, battery age or number of charge/discharge cycles of the lead-acid battery from signals received via the first sensing input. Furthermore, the controller unit is operative to derive a second battery condition of the high-cycle chemical battery from the second sensing input and to select the discharge strategy based on the first battery condition and on the second battery condition.

In the second and third discharge strategies disclosed below, the first discharge phase in which only the high-cycle chemical battery is discharged is only realized when a power demand of a connected load is not too high. When there is a high power demand, the lead-acid battery is discharged in parallel according to the design of a hybrid storage device of the present invention. This situation is shown in FIG. 11.

According to a first discharge strategy, the controller unit is operative to start the parallel discharge phase when the charge and discharge control system enters a discharge mode and to terminate the parallel discharge phase when the charge and discharge control system detects that the lead-acid battery has reached a predetermined discharged state of charge. For the lead-acid battery, the discharged state of charge may correspond to a low SoC, for example 30-40%, which is beneficial for the health of the battery. In particular, the discharge strategies are realized by controlling the two-way DC/DC converter through the control output and by controlling a switch connecting one of the terminals of the lead-acid battery to a load through a second control output.

According to a second discharge strategy, the controller unit is operative to first discharge the high-cycle chemical battery until the high-cycle chemical battery has reached a predetermined state of charge “x %” while essentially maintaining a SoC of the lead-acid battery. According to one embodiment, this predetermined SoC is in the interval 50%+/−25%, according to a further embodiment it is in the interval 50%+/−10%, and according to a further embodiment, it is in the interval 50%+/−5%. The parallel discharge phase is started after or when the high-cycle chemical battery has reached the predetermined state of charge and to terminate the parallel discharge phase when the lead-acid battery has reached a predetermined discharged state of charge.

According to a third discharge strategy, the controller unit is operative to first discharge the high-cycle chemical battery until the high-cycle chemical battery has reached a first predetermined state of charge “x %” while essentially maintaining the SoC of the lead-acid battery. According to one embodiment, the first predetermined SoC “x %” is in the interval 50%+/−25%; according to a further embodiment it is in the interval 50%+/−10%; and according to a further embodiment it is in the interval 50%+/−5%.

Furthermore, the controller unit is operative to discharge the lead-acid battery to a second predetermined state of charge “y %” while essentially maintaining the SOC “x %” of the high-cycle chemical battery after or when the high-cycle chemical battery has reached the second predetermined state of charge. According to one embodiment, the second predetermined SoC “y %” is in the interval 50%+/−25%; according to a further embodiment it is in the interval 50%+/−10%; and according to a further embodiment, it is in the interval 50%+/−5%.

Furthermore, the controller unit is operative to start the parallel discharge phase after or when the lead-acid battery has reached the second predetermined state of charge “y %” and to terminate the parallel discharge phase when the lead-acid battery (12) has reached a predetermined discharged state of charge.

According to a fourth discharge strategy, the controller unit is operative to first discharge the lead-acid battery to a predetermined state of charge “y %”, which is in the interval 50%+/−25% according to one embodiment, in the interval 50%+/−10% according to a further embodiment, and in the interval 50%+/−5% according to a further embodiment, while essentially maintaining the SoC of the high-cycle chemical battery. Furthermore, the parallel discharge phase is started after or when the lead-acid battery has reached the predetermined state of charge “y %” and is terminated when the lead-acid battery has reached a predetermined discharged state of charge.

According to a further embodiment, the controller unit is operative to control the control output in response to signals of the first and third sensing inputs such that the high-cycle chemical battery reaches a predetermined discharged state of charge essentially at the same time when the lead-acid battery reaches the predetermined discharged state of charge.

In particular the hybrid battery-charging may comprise a flooded lead-acid battery that is connected to the first battery connections, wherein the hybrid battery-charging device comprises a concentration sensor for measuring an electrolyte concentration of the flooded lead-acid battery, the concentration sensor being connected to the first sensing input of the charge and discharge control system. Flooded lead-acid batteries are readily available and can be replenished when they have experienced a water loss.

In one particular embodiment, the concentration sensor of the flooded lead-acid battery comprises one or more optical fibres. The optical fibres may extend to different heights in the electrolyte, whereby a stratification of the electrolyte can be detected.

According to another embodiment, the hybrid battery-charging device comprises a dry lead-acid battery, or in other words, a lead-acid battery which is not a flooded lead-acid battery, that is connected to the first battery connections, for example an absorptive glass mat lead-acid battery or a gel lead-acid battery.

According to a further embodiment, the hybrid battery-charging device comprises a voltage sensor for measuring an open circuit voltage of the dry lead-acid battery. The voltage sensor is connected to the first sensing input of the charge and discharge control system and the charge and discharge control system is operative to interrupt a charging or discharging cycle for measuring the open circuit voltage.

According to the present invention, various devices can be provided to measure a state of charge and/or an external resistance of the lead-acid battery.

According to one embodiment, the hybrid battery-charging device comprises an external coil for measuring a state of charge, which is placed in proximity to the dry lead-acid battery and the external coil being connected to the first sensing input of the charge and discharge control system.

According to another embodiment, the hybrid battery-charging device comprises a resonance circuit for applying an alternating voltage signal to terminals of the dry lead-acid battery and a voltage sensor for measuring a response signal of the dry lead-acid battery. The resonance circuit is connected to a control output of the charge and discharge control system and the voltage sensor being connected to the first sensing input of the charge and discharge control system.

According to another embodiment, the hybrid battery-charging device comprises one or more electrodes for measuring an electrochemical noise of the dry lead-acid battery. The one or more electrodes are connected to the first sensing input of the charge and discharge control system. The electrochemical noise may include, among others, current noise, potential noise that is measured without external current, under potentiostatic control or under galvanostatic control.

According to a further aspect, the present invention relates to a method for charging a hybrid battery storage device with a lead-acid battery and a high-cycle chemical battery in a hybrid storage device in which a two-way DC/DC converter is connected between terminals of the high-cycle chemical battery and terminals of the lead-acid battery (12).

A state of charge of the lead-acid-battery is sensed, wherein sensing includes generating an electric signal with a sensor and using a controller unit to derive a value from the electric signal. Furthermore, an internal resistance of the lead-acid battery and a state of charge of the high-cycle chemical battery are sensed.

By evaluating signals from the second sensing input, it is detected when an internal resistance of the lead-acid battery exceeds a predetermined resistance threshold. If the lead-acid battery exceeds the predetermined internal resistance threshold, the two-way DC/DC converter is controlled such that, in a discharge mode, the lead-acid battery and the high-cycle chemical battery are discharged in parallel during a parallel discharge phase.

Furthermore, by evaluating the change of internal resistance and/or further measurements, the controller unit may detect the cause of an increased internal resistance, such as aging, low temperature, an undersized battery or inserting a battery with an unsuitable battery technology.

According to a further embodiment, the parallel discharge phase is started after entering into a discharge mode. If it is detected that the lead-acid battery has reached a predetermined discharged state of charge, the parallel discharge phase is terminated.

According to a further embodiment, a first battery condition such as battery health, battery age, number of cycles of the lead-acid battery is derived from signals of a first sensing input of a charge and discharge control system. A second battery condition of the high-cycle chemical battery is derived from signals of a second sensing input of the charge and discharge control system. A discharge strategy is selected based on the first battery condition and on the second battery condition.

According to a first discharge strategy, a discharge method comprises the following steps. The parallel discharge phase is started when the charge and discharge control system (14, 18) enters a discharge mode and the parallel discharge phase is terminated when the charge and discharge control system detects that the lead-acid battery (12) has reached a predetermined discharged state of charge. In particular, this is achieved by controlling the DC/DC converter through a control output and by controlling a switch connecting one of the terminals of the lead-acid battery to a load through a second control output.

According to a second discharge strategy, a discharge method comprises the following steps. The high-cycle chemical battery is first discharged until the high-cycle chemical battery has reached a predetermined state of charge “x %”, which is in the interval 50%+/−25% in one embodiment, in the interval 50%+/−10% in another embodiment, or in the interval 50%+/−5% in another embodiment. The parallel discharge phase is started after or when the high-cycle chemical battery has reached the predetermined state of charge “x %” and is terminated when the lead-acid battery has reached a predetermined discharged state of charge.

According to a third discharge strategy, a discharge method comprises the following steps. First, the high-cycle chemical battery is discharged until the high-cycle chemical battery has reached a first predetermined state of charge “x %”, which is in the interval 50%+/−25% in one embodiment, in the interval 50%+/−10% in another embodiment, while essentially maintaining the SOC of the lead-acid battery.

Then, the lead-acid battery is discharged to a second predetermined state of charge “y %”, which is in the interval 50%+/−25% in one embodiment, in the interval 50%+/−10% in another embodiment, while essentially maintaining the SOC of the high-cycle chemical battery.

After or when the lead-acid battery has reached the predetermined state of charge “y %”, the parallel discharge phase is started and when the lead-acid battery (12) has reached a predetermined discharged state of charge the parallel discharge phase is terminated.

According to a fourth discharge strategy, a discharge method comprises the following steps.

First, the lead-acid battery is discharged to a predetermined state of charge “y %”, which is in the interval 50%+/−25% in one embodiment, and in the interval 50%+/−10% in another embodiment, while essentially maintaining the SOC of the high-cycle chemical battery.

After or when the lead-acid battery (12) has reached the predetermined state of charge “y %”, the parallel discharge phase is started and when the lead-acid battery (12) has reached a predetermined discharged state of charge, the parallel discharge phase is terminated.

According to a further embodiment, the two-way DC/DC converter is controlled, in response to signals of the first and second sensing inputs, such that the high-cycle chemical battery reaches a predetermined discharged state of charge essentially at the same time when the lead-acid battery reaches the predetermined discharged state of charge.

According to a further embodiment, the discharge method comprises determining an internal resistance of the lead-acid battery by measuring an electrolyte concentration.

According to a further embodiment, the discharge method comprises determining an internal resistance of the lead-acid battery by measuring an open circuit voltage.

According to a further embodiment, the discharge method comprises determining an internal resistance of the lead-acid battery by measuring an impedance of the lead-acid battery, for example by measuring a battery resonance frequency, or by measuring a variation of the inductance of an external sense coil.

Furthermore, the present invention provides a hybrid battery-charging device with input terminals for connecting a photovoltaic panel and first battery connections for connecting a lead-acid battery. A lead-acid battery according to the present invention comprises various types such as a liquid acid battery, a lead-gel battery or an absorbent glass mat (AGM) lead-acid battery.

Furthermore, the battery-charging device comprises second battery connections for connecting a high cycle chemical battery. Preferentially, a lithium battery such as a lithium-ion battery or a lithium polymer battery provides the high-cycle chemical battery but other high cycle chemical batteries such as a Nickel-Iron battery may also be used.

Within the context of the present invention, a “chemical battery” refers to a battery in which a charging or discharging of the battery involves the movement of ions and chemical reactions at the respective anodes of the battery. This stands in contrast to capacitors such as plate capacitors, electrolytic capacitors or double layer capacitors, which are also known as super-capacitors, wherein charging or discharging merely involves the rearrangement of electrons or of other charged particles without a chemical reaction taking place. Furthermore, a high-cycle chemical battery according to the present invention is a rechargeable battery.

According to the present invention, the characteristics of a high-cycle chemical battery complement the characteristics of the lead-acid battery. The lead-acid battery is well adapted to being fully charged or even slightly overcharged while the high-cycle chemical battery is well adapted to a deeper discharge level. Lead acid-batteries are relatively inexpensive and are often used for remote energy systems. Such a lead-acid battery can even be provided by a simple car battery but it is more advantageous to use specially adapted batteries which tolerate deeper discharges.

The battery-charging device comprises a two-way DC/DC converter, which is also known as bidirectional DC/DC converter. The two-way DC/DC converter is used to charge the lithium battery in a first current direction as well as to discharge the lithium battery in a second current direction.

A first set of terminals of the two-way DC/DC converter is connected with the second battery connections and a second set of terminals of the two-way DC/DC converter is connected with the first battery connections. An input to the second set of terminals is derived from the input terminals of the hybrid battery-charging device. Herein, an input of B being “derived” from A means that B receives an input from A, wherein the input may be transmitted from A to B directly via an electric line or indirectly via other components such as switches, transistors etc.

Furthermore, a charge and discharge control system is provided, which is connected to the two-way DC/DC converter via respective control lines and output terminals for connecting a load. An input of the output terminals is derived from the first battery connections via a connecting means for connecting the output terminals to the first battery connections, such as a magnetic switch or a semiconductor switch.

In the direct current circuits of the hybrid battery-charging device, either one of the poles may be connected to a common ground in a known way. For example, a minus pole connection of the first battery connections and a minus pole terminal of the output terminals may be connected to a common ground potential. In other words, one of the respective battery connections and one of the output terminals may be provided by respective connections to the common ground potential. The input terminals of the two-way DC/DC converter are also referred to as “system terminals” and the voltage across the system terminals is also referred to as “system voltage”.

Furthermore, the hybrid battery-charging device may comprise a control device such as a controlled on/off switch, a pulse width modulation (PWM), a maximum power point tracker, etc. for better controlling the charge voltage of the batteries. The control device is connected between the input terminal of the system and input terminals of the DC/DC converter, which are in turn connected to terminals of the lead-acid battery. Furthermore, the control device is connected to the charge and discharge control system via control lines. For example, the control lines may be configured for switching transistors of a PWM in the control device.

The two-way DC/DC converter may comprise, for example, a buck-boost converter, a buck converter or a boost converter for providing a suitable voltage ratio for charging or discharging the lithium battery. Especially, the two-way DC/DC converter may comprise a step-up converter for providing a higher voltage to the lithium battery than the end-of-charge voltage of the lead-acid battery.

In particular, the two-way DC/DC converter may comprise at least two semiconductor switches, wherein respective input connections of the transistors are connected to the charge control system via respective control lines. In this way, the two-way DC/DC converter is easy to control via electric signals. In particular, the transistors may be realized as power transistors.

Furthermore, the hybrid battery-charging device may comprise first and second voltage measuring connections for connecting first and second voltage sensors. The first voltage sensor is connected to terminals of the lead-acid battery and the first voltage measuring connections are connected to the charge and discharge control system. The second voltage sensor is connected to terminals of the lithium battery and the second voltage measuring connections are connected to the charge and discharge control system, wherein the connection may be direct or also indirect via a separate controller for managing the state of charge of the lithium battery such as a voltage monitoring chip. The voltage monitoring chip may be connected to the voltage sensor of the lithium battery and to the charge control system via a control line.

In particular, the lithium battery, the two-way DC/DC converter and the voltage monitoring chip for the lithium battery may be mounted together in an energy storage subsystem, wherein the energy storage subsystem provides input terminals for plugging the energy storage subsystem into the hybrid battery-charging device. Thereby, the building block comprising the lithium battery can be used and serviced separately from the rest of the hybrid battery-charging device.

The first and second voltage sensors may be provided as component of the hybrid battery-charging device, for example within the charge and discharge control system or they may be provided as components of the respective batteries.

The hybrid battery-charging device may furthermore comprise a separate battery management system for the lithium battery, the separate battery management system that is connected to the charge and discharge control system. In this way, an existing battery-charging device, for example a battery-charging device for a lithium battery, or parts of it may be used in the hybrid battery-charging device according to the present invention.

The present invention also provides to a hybrid storage system with a hybrid charging device according to the present invention that further comprises lithium battery which is connected to the second battery connections.

Furthermore, the hybrid storage system may further comprise a capacitor such as an ultra-capacitor, which is connected in parallel to the lithium battery, for a fast response to high load peaks of a connected load.

Furthermore, the present invention provides to a hybrid storage system with a hybrid charging device according to the present invention that further comprises a lead-acid battery that is connected to the first battery connections.

The hybrid storage system may comprise furthermore a first voltage sensor, which is connected to a terminal or to terminals of the first battery and to the charge and discharge control system, and a second voltage sensor, which is connected to a terminal or to terminals of the second voltage battery and to the charge and discharge control system.

Furthermore, the prevention invention provides a method for charging a lead-acid battery and a lithium battery of a hybrid storage system by an electric power source such as a photovoltaic panel.

According to embodiment of the present invention, a lead-acid battery is charged in a first battery charging phase until the lead-acid battery has reached a first predetermined state of charge. During the first battery charging phase, in which the lead-acid battery is charged, the charging may be controlled just by limiting to a maximum current or to perform unlimited charging or bulk charging, for example by a PID controller which uses the charging voltage and current as input data.

In an equalization phase, which is also known as a topping or boost phase, the lead-acid battery and the lithium battery are both charged until the lead-acid battery has reached a second predetermined state of charge. In addition, the lead-acid battery and the lithium battery may also be charged during an “absorption phase” or a boost phase of the lead-acid battery. In the equalization and absorption phases, the system voltage is kept constant at different setpoints, which correspond to the phases.

During the equalization phase, an applied voltage at the lead-acid battery can be made to oscillate between a predetermined lower voltage and a predetermined upper voltage. In particular, the voltage may be applied by pulse charging, and especially by pulse-width modulated charging. The voltage of the charge pulses may be higher than the end of charge voltage of the lead-acid battery. The charge pulse can contribute to a higher charge and life expectancy of the lead-acid battery by equalizing the charges on the battery cells, mixing the electrolyte and reducing the sulfation. Furthermore, a mean voltage at terminals of the lead-acid battery is close to an end-of-charge voltage of the lead-acid battery during the equalization phase. During the equalization phase, the charge current to the lead-acid battery will decrease because the charge state of the lead-acid battery approaches 100%.

The lithium battery is charged in a third battery charging phase during which an essentially constant system voltage is applied to system terminals of the lead-acid battery and the first voltage is converted into a charging voltage at terminals of the lithium battery.

Advantageously, the essentially constant system voltage that is applied to the system terminals during the charging of the lithium battery in the third battery charging phase is made equal to a maximum open circuit voltage of the lead-acid battery. Thereby, the lead-acid battery will not discharge significantly, even if it remains connected to the lithium battery. On the other hand, an overcharging of the lead-acid battery is avoided by keeping the terminals of the lead-acid battery at its maximum open circuit voltage. In addition, a trickle or standby charge may be applied to the lead-acid battery during which the applied voltage may be higher than the maximum open circuit voltage of the lead-acid battery.

Furthermore, the present invention provides a method for discharging a lead-acid battery and a lithium battery of a hybrid storage system. According to the application, a load is supplied with power by discharging the lithium battery via system terminals of the lead-acid battery. During discharging of the lithium battery, the voltage at the system terminals is maintained essentially equal to a maximum open circuit voltage of the lead-acid battery until a voltage at terminals of the lithium battery has reached an end-of-discharge voltage of the lithium battery.

Thereby, it is not required to provide a direct connection between the lithium battery and the load. This ensures that the lead-acid battery is not already discharged, even if it is not disconnected. A controlled DC/DC converter can provide the required voltage, for example.

If the output voltage of the lithium battery has reached an end-of-discharge voltage of the lithium battery, the lead-acid battery is discharged until the voltage of the lead-acid battery has reached an end-of-discharge voltage of the lead-acid battery. The end-of-discharge voltage of the lead-acid battery is a voltage to which the lead-acid battery can be discharged safely. The end-of-discharge voltage of the lead-acid battery corresponds to a SOC of about 30-40% of the lead-acid battery.

Similarly, if a load draws current from the lithium battery such that a voltage at terminal of the lead-acid battery drops below a maximum open circuit voltage of the lead-acid battery, the lead-acid battery is discharged in parallel with the lithium battery until the lithium battery has reached an end-of-discharge voltage.

In addition, the lead-acid battery may be disconnected after discharging the lead-acid battery and/or the hybrid storage system may enter a standby mode until it is determined that an electric power source can supply enough power to load the first battery. The disconnection of the lead-acid battery may be achieved by an on/off switch for disconnecting the load and/or achieved by a separate on/off switch, which is provided at the lead-acid battery. In particular, the standby mode may provide a reduced power consumption by suspending measurements of a system voltage at terminals of the first battery and of a voltage at terminals of the second battery.

Furthermore, the present invention provides a hybrid battery-charging device according to the present invention wherein the charge and discharge control system is operative for executing a charge or a discharge method according to the present invention. This may be realized for example by providing a computer readable program of a programmable microcontroller or a special purpose circuit, which is provided in the charge and discharge control device of the hybrid battery-charging device.

In general, a hybrid storage system according to the present invention may be used wherever there is a need for an efficient intermediate storage of energy from an energy source. This applies in particular to energy systems in which a supply from an energy source and/or an energy demand of an energy consumer varies over time. More specifically, these conditions apply for off-grid applications, which are supplied by a varying energy source such as solar energy or wind energy. An off-grid solar power station with a hybrid storage system according to the present invention may be used, for example, in remote geographical locations such as the interior of Africa or Brazil. Furthermore, it can also be used for powering installations that are typically located outside of agglomerations such as communication antennas, weather stations, fire observation towers, emergency shelters, devices in outer space etc.

### BRIEF DESCRIPTION OF THE DRAWINGS

Example embodiments of the present invention are explained in further detail with respect to the figures.

FIG. 1 shows a general outline of a hybrid storage system with a lead-acid battery and a lithium battery.

FIG. 2 shows a detailed view of the hybrid storage system.

FIG. 3 shows a discharge curve of a lead-acid battery according to a first discharge method.

FIG. 4 shows a discharge curve of a lithium battery according to the first discharge method.

FIG. 5 shows discharge curves of a lead-acid battery and of a lithium battery according to a second discharge method.

FIG. 6 shows discharge curves of a lead-acid battery and of a lithium battery according to a third discharge method.

FIG. 7 shows discharge curves of a lead-acid battery and of a lithium battery according to a fourth discharge method.

FIG. 8 shows a circuit diagram of the hybrid storage system of FIGS. 1 and 2.

FIG. 9 shows state of charge curves for a 12-volt lead-acid battery of the storage system of FIG. 1 under different conditions.

FIG. 10 shows a system voltage, a state of charge of a lead-acid battery and a state of charge of a lithium battery of the hybrid storage system of FIG. 1 during typical charging and discharging processes.

FIG. 11 shows further parameters of the hybrid storage system of FIG. 1 for a discharge process for a high load.

FIG. 12 shows a flow diagram of a charging and discharging process of the hybrid storage system of FIG. 1.

FIG. 13 shows another hybrid storage system with a first hybrid battery-charging device.

FIG. 14 shows a further hybrid storage system with a second hybrid battery-charging device.

### DETAILED DESCRIPTION OF EXAMPLE EMBODIMENTS

In the following description, details are provided to describe example embodiments of the present invention. It shall be apparent to one skilled in the art, however, that the embodiments may be practiced without such details.

Some parts of the embodiments are similar. The similar parts may have the same names or similar part numbers. The description of one part also applies by reference to another similar part, where appropriate, thereby reducing repetition of text without limiting the disclosure.

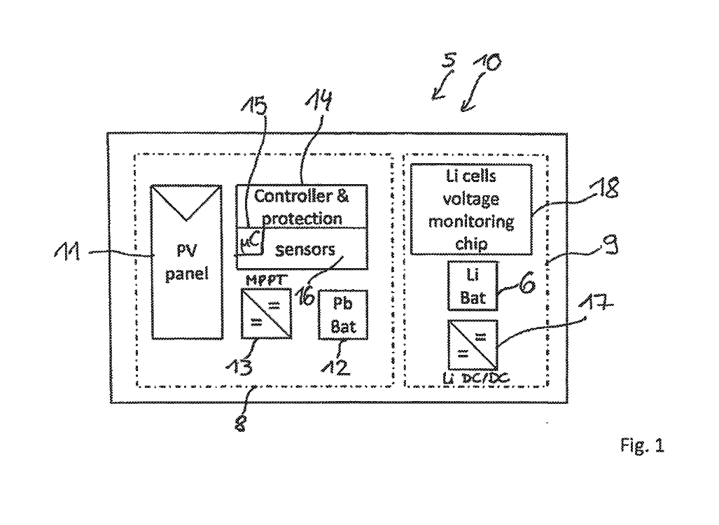

FIG. 1 shows a general layout of a hybrid storage system 5 with a hybrid battery-charging device 10. According to an example embodiment of the present invention, the hybrid storage system 5 comprises at least one battery while a hybrid battery-charging device does not necessarily include the batteries.

The hybrid storage system 5 comprises a first energy storage subsystem 8 with a photovoltaic panel 11 and a second energy storage subsystem 9. The first energy storage subsystem 8 comprises a lead-acid battery 12, a unidirectional DC/DC converter 13 and a charge control system 14. The charge control system 14 comprises a microcontroller 15 and sensors 16. The sensors 16 comprise a voltage sensor at the terminals of the lead-acid battery 12. The DC/DC converter 13 is connected to a maximum power point tracker (MPPT). The maximum power point tracker provides an impedance matching for the photovoltaic panel 11 and it may be realized by a portion of the charge control system 14 and further hardware components.

Typically, the MPPT uses a measurement of the voltage across the photovoltaic panel 11, a measurement of an electric current from the photovoltaic panel 11 and, optionally, further measurements to generate a control signal corresponding to a reference voltage and/or to a reference current. MPPT algorithms comprise constant voltage, perturb and observe and incremental conductance algorithms.

Especially for remote energy systems with higher output powers (e.g. above 300 Watt) it is advantageous to use a maximum power point tracker (MPPT) in a system according to the present invention. Thereby, it is possible to achieve high efficiencies. However, a system according to the present invention can also be operated as with an off-grid solar systems without an MPPT or input-DC/DC converter 13.

The second energy storage subsystem 9 comprises a lithium battery 6, a bidirectional DC/DC converter 17 and a voltage monitoring chip 18. The DC/DC converters 13 and 17 may be implemented in various ways, for example as buck converters, as boost converters or as buck-boost converters.

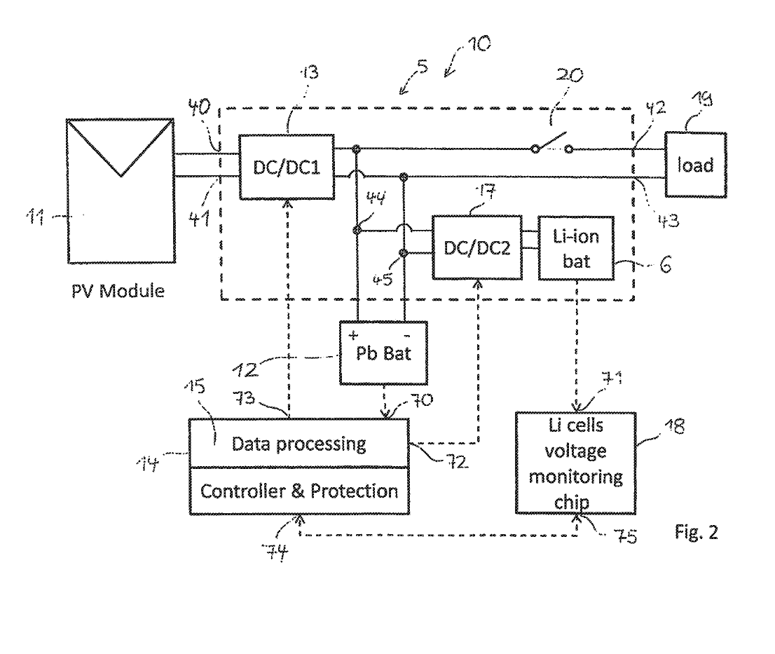

FIG. 2 shows a detailed view of the layout of FIG. 1. According to the layout of FIG. 2, the lithium battery 6 is connected in parallel to the lead-acid battery 12 and to a load 19 via the bidirectional DC/DC converter 17. Furthermore, output lines of the DC/DC converter are connected in parallel to the lead-acid battery 12. A load switch 20 is connected in series to the load 19. The load switch 20 is provided to prevent a deep discharge and it may be implemented as a semiconductor switch such as a bipolar transistor, a FET, an IGBT, or others. An arrow 7 indicates a direction of current.

Dashed arrows in FIG. 2 indicate the flow of sensor signals to the charge control system 14 and to the voltage monitoring chip 18, the flow of signals between the charge control system 14 and the voltage monitoring chip and the flow of control signals from the charge control system 14. The charge control system 14 comprises a sensing input 70 for receiving sensor signals from the lead-acid battery 12, a second sensing input 74, a first control output 72 for controlling the two-way DC/DC converter 17 and a second control output 73 for controlling the DC/DC converter 13.

The lithium cell voltage monitoring chip 18 comprises a sensing output 71 and a communication port 75. In the embodiment of FIG. 2, the second sensing input 74 of the charge and discharge control system 14 and the communication port 75 are provided for bidirectional communication. According to another embodiment, the charge and discharge control system 14 and the lithium cell voltage monitoring chip 18 each have an input and an output port which are provided for unidirectional communication between the charge and discharge control system 14 and the lithium cell voltage monitoring chip 18.

The hybrid storage system provides a positive input terminal 40 and a negative input terminal 41, which are connected to corresponding output terminals of the photovoltaic panel 11, and a positive output terminal 42 and a negative output terminal 43, which are connected to corresponding input terminals of the load 19. The lithium subsystem 9 comprises a positive input terminal 44 and a negative input terminal 45, which are connected to respective terminals of the lead-acid battery 12. Furthermore, the lithium subsystem 9 comprises a positive output terminal 46 and a negative output terminal 47 which are connected to respective terminals of the lithium battery 6.

For a load 19 that comprises an AC consumer, a DC/AC converter may be connected between the output terminals 42 and 43 and the load 19. A DC/AC converter may be provided, for example by a switched H-bridge or a switched three-phase inverter.

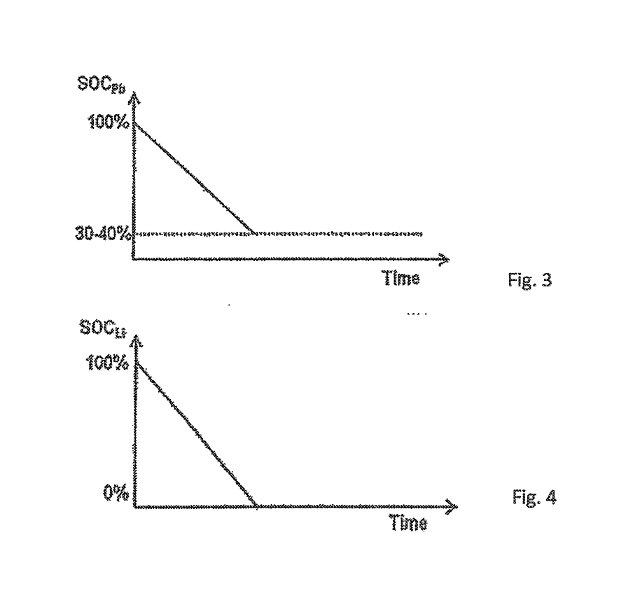

FIGS. 3 to 6 show control strategies for discharging of a lithium battery in support of a lead-acid battery which shows a high internal resistance. In the embodiments of FIGS. 3 to 6, the internal resistance of the lead-acid battery already exceeds the threshold resistance at the beginning of the discharge cycle when the lead-acid battery is fully charged. However, a high internal resistance may also be detected at a later time during the discharge cycle. In the context of the present invention, a state of charge of 100% refers to the capacity that the battery is presently able to support or to the maximum amount of charge that the battery takes up after a charge cycle is completed. This capacity may be different from the capacity that the battery initially had or from the maximum capacity according to its factory specifications.

FIGS. 3 and 4 show discharge curves of a lead-acid battery and of a lithium battery according to a first discharge control strategy.

According to the first discharge control strategy, a lead-acid and a lithium battery are discharged in parallel if an internal resistance of a lead-acid battery exceeds a threshold resistance. Discharging of the lead-acid battery is stopped at an SOC of about 30-40% and discharging of the lithium battery is stopped before deep discharge sets in.

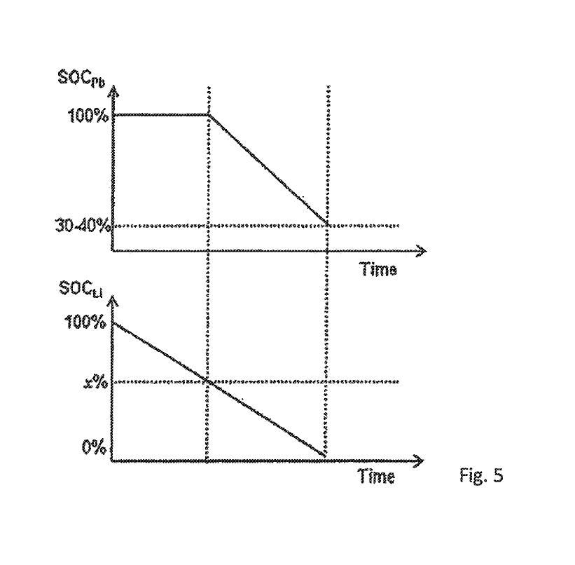

FIG. 5 shows discharge curves of a lead-acid and of a lithium battery according to an alternative second discharge control strategy. According to the second discharge control strategy, the lithium battery is discharged first after a high internal resistance of the lead-acid-battery is detected and the lead-acid battery is held in the same state of charge. When it is detected that the lithium battery has reached a predetermined state of charge of x %, the lithium battery and the lead-acid battery are discharged in parallel. Discharging of the lead-acid battery is stopped at an SOC of about 30-40% and discharging of the lithium battery is stopped before deep discharge sets in. In one embodiment, x is a predetermined value in the interval with the boundaries 50%+/−25%.

As the lead-acid battery is only discharged after the state of charge of the lithium battery has reached the predetermined level of x %, the lead-acid battery is cycled fewer times and its life expectancy is enhanced.

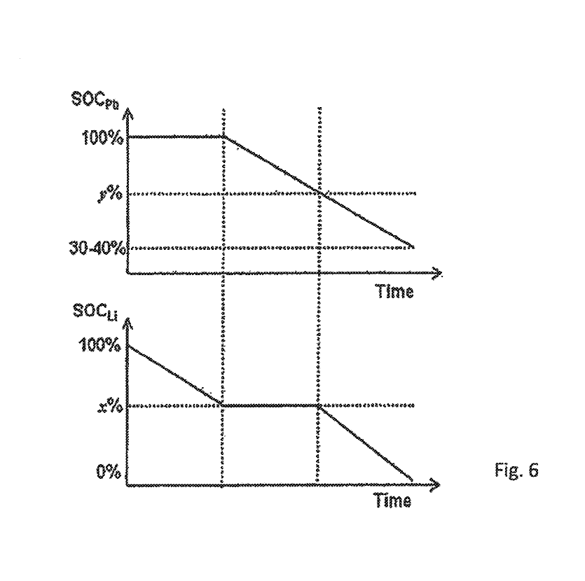

FIG. 6 shows discharge curves of a lead-acid and of a lithium battery according to an alternative third discharge control strategy. According to the third discharge control strategy, the lithium battery is discharged first after a high internal resistance of the lead-acid-battery is detected. When it is detected that the lithium battery has reached a predetermined state of charge of x %, only the lead-acid battery is discharged while the lithium battery is held at the same charge state.

When it is detected that the lead-acid battery has reached a second predetermined state of charge of y %, the lead-acid battery and the lithium battery are discharged in parallel. Discharging of the lead-acid battery is stopped at an SOC of about 30-40% and discharging of the lithium battery is stopped before deep discharge sets in. In one embodiment, y is a predetermined value in the interval with the boundaries 50%+/−25%.

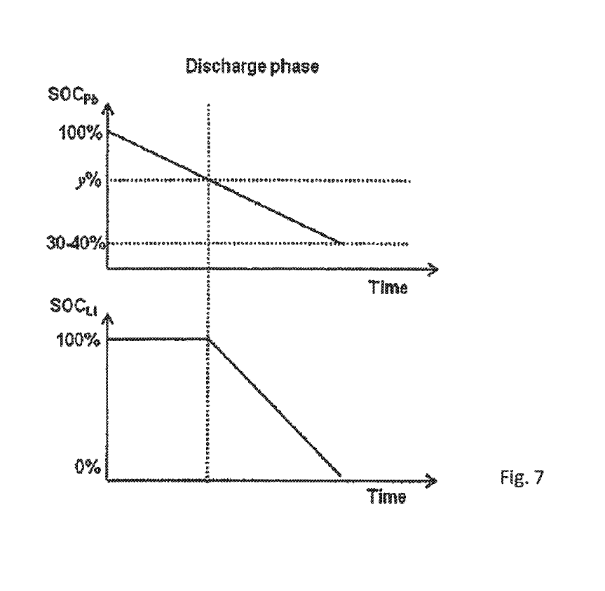

FIG. 7 shows discharge curves of a lead-acid and of a lithium battery according to an alternative fourth discharge control strategy. According to the fourth discharge control strategy, only the lead-acid battery is discharged after a high internal resistance of the lead-acid-battery is detected. When it is detected that the lead-acid battery has reached a predetermined state of charge of y %, the lead-acid battery and the lithium battery are discharged in parallel. Discharging of the lead-acid battery is stopped at an SOC of about 30-40% and discharging of the lithium battery is stopped before deep discharge sets in.

According to the fourth discharge control strategy, the lead-battery is cycled the most of all four control strategies and will therefore age more rapidly. By contrast, the lithium battery is cycled less often and has a longer life expectancy.

According to the present invention, a charge controller may select one of the four discharge control strategies of the FIGS. 3 to 7 according to predetermined criteria. The selection of the control strategy may depend on the aging of the batteries. For example, if it is detected that the properties of the lithium battery have already deteriorated significantly the controller may choose a discharge strategy that puts less stress on the lithium battery. On the other hand, if it is detected that the properties of the lead-acid battery have already deteriorated significantly, the controller may choose a discharge strategy that puts less stress on the lead-acid battery. In one embodiment, the priorities of the discharge control strategies are user configurable. For example, a user may decide that one of the batteries is especially expensive or difficult to replace, and select a control method or assign a high priority to a control method that puts the least stress on this battery.

The discharge methods according to FIGS. 3-7 may be realized with the hybrid storage system 10 shown in FIG. 1, by way of example.

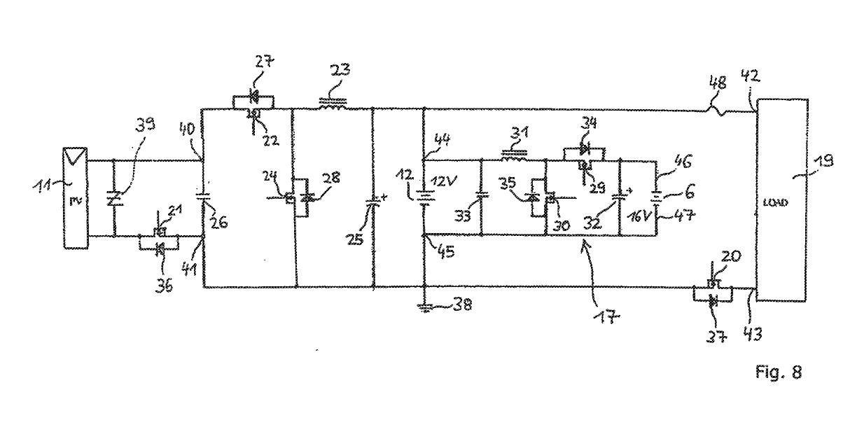

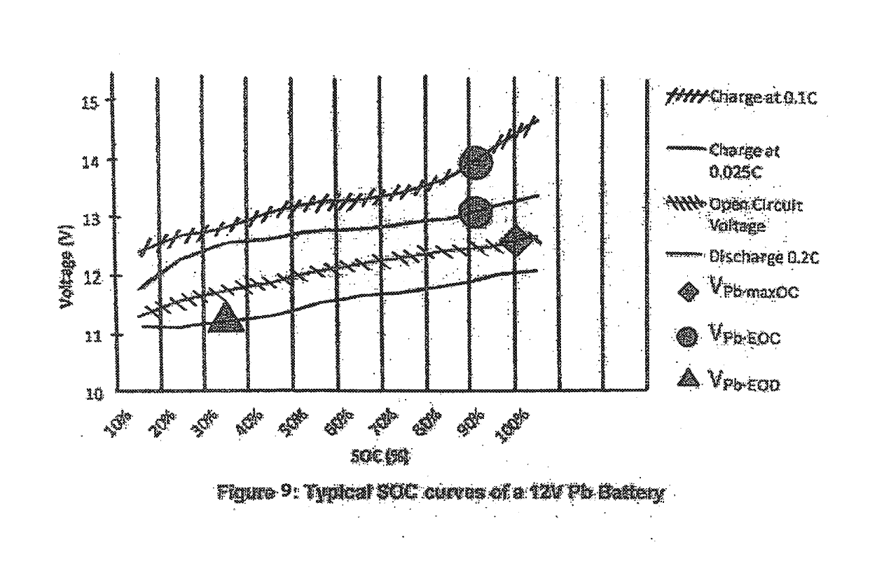

FIG. 8 shows a circuit diagram of the hybrid storage system 5 according to FIG. 2. In the example of FIG. 8, the lead-acid battery 12 can deliver a voltage of around 12 V and the lithium battery 6 can deliver a voltage of around 24 V. The photovoltaic panel 11 is connected to the hybrid storage system 5 via a reverse current protection MOSFET 21. A TVS-diode 39 for transient voltage suppression (TVS) and overvoltage suppression is connected in parallel to the photovoltaic panel 11.

The DC/DC converter 13, which is connected to outputs of the photovoltaic panel 11 and to battery terminals of the lead-acid battery 12, comprises a first MOSFET 22, a second MOSFET 24 and inductor 23, which are connected in star connection. A first terminal of a capacitor 25 is connected to a plus pole battery terminal of the lead-acid battery 12 and a second terminal of the capacitor 25 is connected to a minus pole battery terminal of the lead-acid battery 12.

Furthermore, a second capacitor 26 is connected in parallel to the input terminals 40 and 41 and works as an input filter. The first MOSFET 22 comprises a parasitic diode 27 and the second MOSFET comprises a parasitic diode 28.

During operation, the output power of the photovoltaic panel 11 or of the DC/DC converter 13 is measured by the charge control system 14. A control signal of the charge control system. 14 adjusts the ratio of the DC/DC converter 13 via opening and closing of the MOSFETS 22 and 24 according to a maximum power point of the photovoltaic panel 11.

The DC/DC converter 17, which is connected to battery terminals of the lithium battery 6 and to battery terminals of the lead-acid battery 12, comprises a first MOSFET 29, a second MOSFET 30 and inductor 31 which are connected in star connection. A plus pole battery terminal of the lithium battery 6 is connected to a first terminal of a capacitor 32 and a minus pole battery terminal of the lithium battery 6 is connected to a second terminal of the capacitor 32.

The capacitors 25, 26, 32 and 33, on the other hand, act as filters for smoothing out the output voltage.

The first MOSFET 29 comprises a parasitic diode 34 and the second MOSFET 30 comprises a parasitic diode 35. The protection MOSFET 21 comprises a parasitic diode 36 and the load switch 20 comprises a parasitic diode 37. The parasitic diodes 27, 28, 34, 35, 36 and 37 also act as freewheel diodes with respect to the corresponding MOSFETS 22, 24, 29, 30, 21 and 20. Instead of MOSFETS, other field effect transistors may be used as well, like, for example, IGBTs, JFETs and others.

A fuse 38 is provided close to a positive output terminal of the hybrid storage system 5 to protect the circuitry of the hybrid storage system 5 from overload. A ground potential 38 is connected to the minus pole terminal of the lead-acid battery 12, to the minus pole terminal of the lithium battery 6 and to respective terminals of the capacitor 25, the second MOSFET 24 and the second capacitor 26 of the DC/DC converter 13.

According to the embodiment of the present invention, separate switches at the batteries 6, 12 are not required. The lead-acid battery 12 and the lithium battery 6 may be equipped with switches, respectively, for connecting and disconnecting the lead-acid battery 12 and the lithium battery 6, however.

The DC/DC converter 13 is controlled through control signals at the respective gate electrodes of the MOSFETS 24 and 22 and the DC/DC converter 17 is controlled through control signals at the respective gate electrodes of the MOSFETS 29 and 30. The DC/DC converters 13 and 17 can be operated as charge pulse generators by applying pulse width modulated pulses at the respective bases or gates of the respective transistors.

In a charge mode, the charge pulses can be used for charging the batteries lead-acid battery 12 and the lithium battery 6 and, in a recovery mode, they can be used for desulfurization of the lead-acid battery 12. With respect to charging, the term “pulse-width modulation” (PWM) refers to applied signals at semiconductor switches. The generated charge or voltage pulses will in general not take the shape of rectangular pulses. This is different from the output of a switched H-bridge for driving a motor via PWM, for example.

During operation, a voltage of the lithium battery 6 is measured by the voltage monitoring chip 18 and a voltage of the lead-acid battery 12 is measured by the charge control system 14. The charge control system 14 adjusts the current of the DC/DC converter 13 via control signals to the MOSFETS 22 and 24. Similarly, the charge control system 14 adjusts the current or power through the DC/DC converter 17 via control signals to the MOSFETS 29 and 30. By increasing the input voltage through the DC/DC converters 13 and 17, the photovoltaic panel can be used for charging the batteries 12 and 6 even in periods of weaker insolation.

Furthermore, the charge control system 14 controls the opening and closing of the protection MOSFET 21 and of the load switch 20 by respective control signals.

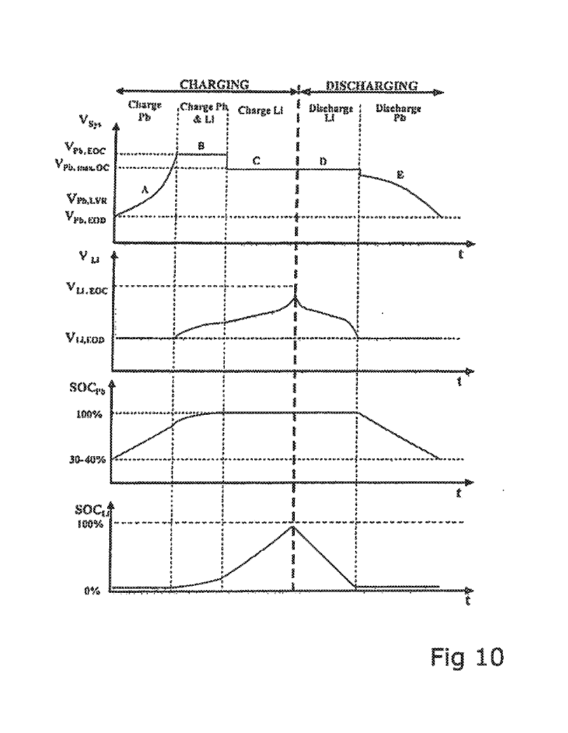

The generation of the control signals of the charge control system 12 according to the present invention is now explained in more detail with respect to the following FIGS. 9 and 10.

FIG. 9 shows state of charge curves for a 12-volt lead-acid battery under different conditions. The topmost curve shows an external voltage that is required for charging the lead-acid battery at a charge rate of 0.1 C. This charge rate signifies a capacity of a battery in ten hours. At a charge rate of 0.1 C, the lead-acid battery reaches an end-of-charge voltage V_EOC of about 13.5V at a state of charge (SOC) of about 90%, which is indicated by a circle symbol. The second curve from the top shows an external voltage that is required for charging the lead-acid battery at a charge rate of 0.025 C. In this case, the lead-acid battery reaches an end-of-charge voltage V_EOC of about 13V at a state of charge of about 90%, which is indicated by a circle symbol.

The second curve from below shows open circuit voltages for different charge states of the lead-acid battery. A maximum open circuit voltage V_maxOC of about 12.5 Volt is marked by a diamond symbol. The lowest curve shows a voltage that is delivered by the lead-acid battery when a load is chosen such that the lead-acid battery is discharged at a discharge rate of about 0.2 C. At a charge state of about 35% battery charge, an end of discharge voltage is reached. The voltage V_EOD between the battery terminals of the lead-acid battery at the end of discharge, which is at about 11.2 Volt, is marked by a triangle symbol.

In general, the following voltages are used in the control algorithms according to the example embodiment of the present invention.
V_Sys, which corresponds to the voltage of the lead-acid battery 12 and to the voltage at the second set of terminals of the DC/DC converter 17. According to the application, a decision on which battery is charged or discharged depends on V_sys and, as an option, on the current.
V_EOC, which denotes an end-of-charge voltage. In lithium batteries, this voltage (V_Li_EOC) can correspond to a SOC of about 100%. By contrast, the end-of-charge voltage in lead (Pb) batteries (V_Pb_EOC) corresponds to a SOC of 85-90%. In order to reach an SOC of 100%, the lead-acid battery has to be charged further after the end-of-charge voltage has been reached. As shown in FIG. 9, the voltage V_Pb_EOC can depend on the charge rate. Furthermore, it also depends on characteristics of the lead-acid battery such as age and operating temperature.
V_EOD, which denotes an end-of-discharge voltage. In lithium batteries, this voltage (V_Li_EOD) corresponds to a certain low level of SOC, whereas in lead batteries, in order to avoid damage to the battery, this voltage (V_Pb_EOD) will correspond to a SOC of e.g. 30-35%, as shown in FIG. 8. The voltage V_Pb_EOD depends also on the discharge current, age of the battery and battery temperature. It does not correspond to a predetermined fixed value in the control storage algorithm.

In a charging method according to the present invention, a pulse width modulation (PWM) charging mode is used to charge the lead-acid battery 12. The PWM charging mode provides an efficient charging mode for lead-acid batteries. A surplus energy, which is not needed for the PWM charging of the lead-acid battery 12, is automatically transferred to the lithium battery 6 of the lithium subsystem 9. Thereby, a surplus of electric energy from the photovoltaic cells 11 is used to charge the lithium battery 6.

In a discharging method according to the present invention, the lithium subsystem is controlled to maintain a system voltage V_sys at a threshold voltage that corresponds to a voltage of the fully charged lead-acid battery 12. The system voltage V_sys is indicated in FIG. 2 by an arrow and it is measured between the connection lines to the lead-acid battery 12, which are connected to terminals of the lithium subsystem 9.

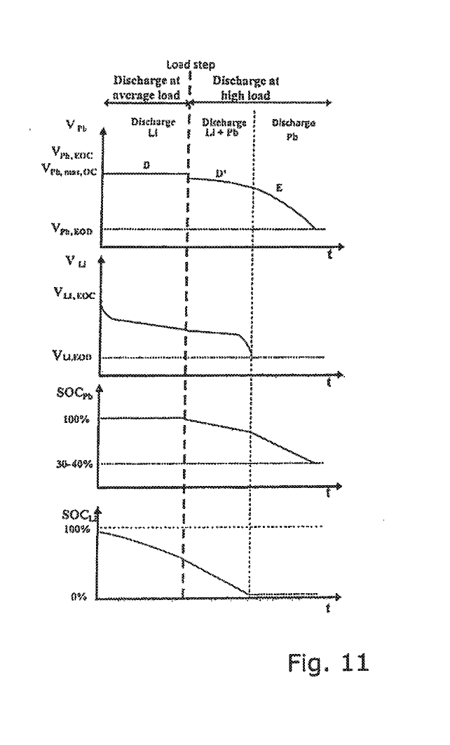

FIG. 10 shows voltage and state of charge diagrams for the lead-acid battery and for the lithium battery during a charging process according to the present invention. In FIGS. 10 and 11, system states, which are determined by the charge states of the two batteries are labelled by letters A to E. The letters correspond to labels in the flow diagram of FIG. 11. The letters A-E furthermore denote charge and discharge phases. As shown in FIG. 10, there is an additional discharge phase D-D′ when the load draws more power than the lithium battery 6 can deliver. In this case the lead-acid battery, which is also connected to the load will discharge simultaneously as the system voltage falls below the end of charge voltage of the lead-acid battery 12.

During the charging and the discharging process the charge control system 14 estimates the states of charge SOC_Pb and SOC_Li of the batteries 6, 12 based on the time dependence of the system voltage and/or on the current supplied to the batteries 6, 12.

In a first charging phase A, only the lead-acid battery 12 is charged. In the example of FIG. 10, a voltage at the lead-acid battery 12 is at an end-of-discharge voltage V_Pb_EOD and a voltage at the lithium battery 6 is at an end-of-discharge voltage V_Li_EOD.

During the first charging phase, the state of charge of the lead-acid battery 12 increases. The system voltage V_sys at terminals of the lead-acid battery 12 is measured in regular time intervals. As soon as the system voltage V_sys reaches the end-of-charge voltage V_Pb_EOC of the lead-acid battery 12, a second charging phase starts. In the second charging phase B, the lead-acid battery and the lithium battery are both charged. As soon as the state of charge SOC_Pb of the lead-acid battery 12 reaches approximately 100%, a third charging phase C is started, in which the lithium battery 6 is charged with a current and the lead-acid battery 12 is kept at the same SOC with a trickle charge. This can be seen in the state of charge diagrams, which show an increase of the lithium battery's state of charge and a constant state of the charge for the lead-acid battery.

FIG. 10 shows furthermore a discharging process according to the present invention for a situation in which both batteries 6, 12 are fully charged at the beginning of the discharging process. In a first discharging phase D, only the lithium battery 6 is discharged. In the example of FIG. 9, the discharge current from the lithium battery 6 is approximately constant. As soon as the state of charge of the lithium battery 6 reaches a lower bound, only the lead-acid battery is discharged in a second discharge phase E.

In the example of FIG. 10, the time when the lower bound of SOC_Li is reached, is determined by the moment in which the voltage at the lithium battery drops to an end-of-charge voltage V_Li_EOC. The charge control system 14 disconnects the lead-acid battery 12 from the load by opening the load switch 12 when the system voltage V_sys reaches an end-of-discharge voltage V_Pb_EOD.

FIG. 11 shows a second discharging process, wherein, in a discharge phase D′, the load draws more current than the lithium battery is able to deliver. In this case, the system voltage V_sys at the terminals of the lead-acid battery 12 drops below the maximum open circuit voltage V_PB_max_OC of the lead-acid battery, as shown in the topmost diagram of FIG. 10, and the lead-acid battery 12 is discharged together with the lithium battery 6. The discharge phases D′ and E are similar to those described with reference to FIG. 9.

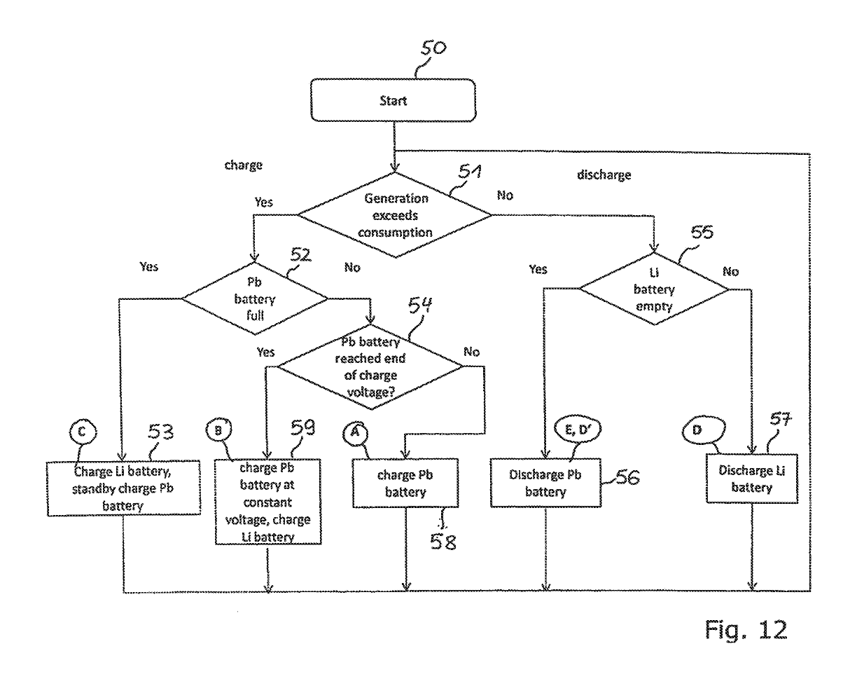

FIG. 12 shows a flow diagram of the discharging and the charging process which indicates the operation principle of the charge control system 14.

In a step 50, a charge/discharge control is activated, for example by plugging in the lead-acid battery 12 and the lithium battery 6. This may involve additional steps, such as checking the health of the batteries and the correct connection of the batteries. In a decision step 51, it is decided whether enough power is available to charge the batteries. In a decision step 52, it is decided if the lead-acid battery 12 is fully charged, for example, by measuring the system voltage V_sys. If the lead-acid battery 12 is determined as fully charged, the lithium battery 6 is charged and the lead-acid battery 12 is provided with a trickle charge in a step 53. If it is determined in step 52 that the lead-acid battery 12 is not yet fully charged, it is decided, in a decision step 54, if the lead-acid battery 12 has reached an end-of-charge voltage.

If the lead-acid battery 12 has not yet reached the end-of-charge voltage, it is charged in a step 58. If, on the other hand, it is determined that the lead-acid battery has reached the end-of-charge voltage, the lead-acid battery 12 is charged at a constant voltage while the lithium battery 6 is charged simultaneously.

If, in the decision step 51, it is determined that the generation does not exceed the consumption and the consumption is greater than zero, it is determined, in a decision step 55, if the lithium battery 6 is empty, wherein “empty” corresponds to a low SOC. If it is determined that the lithium battery 6 is empty, the lead-acid battery 12 is discharged in a step 56 while the state of charge SOC_Pb of the lead-acid battery 12 exceeds a lower bound of 30-40%, for example.

If, on the other hand, it is determined in step 55, that the lithium battery 6 is not empty, the lithium battery 6 is discharged in a step 57. If, during execution of step 56, a load draws more current than the lithium battery 6 can supply, a voltage at terminals of the lead-acid battery 12 drops below the end-of-charge voltage V_EOC_Pb and the lead-acid battery 12 will also be discharged.

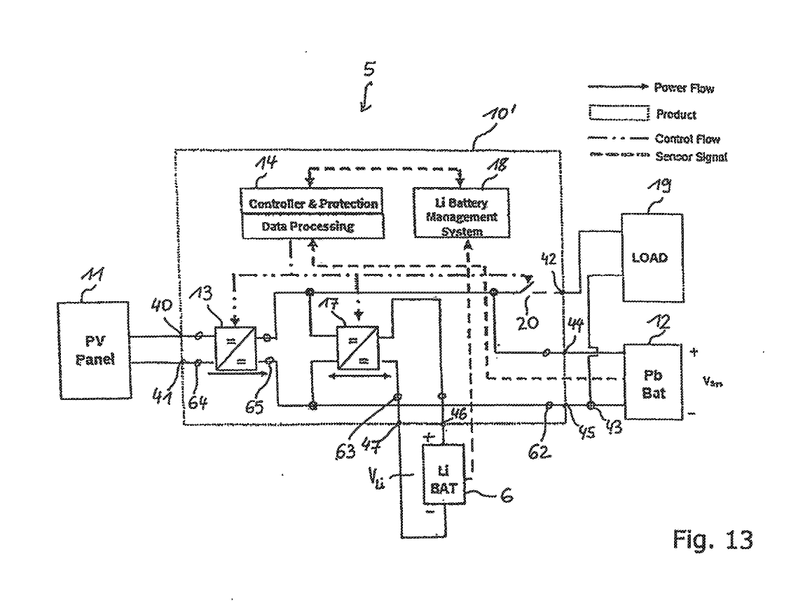

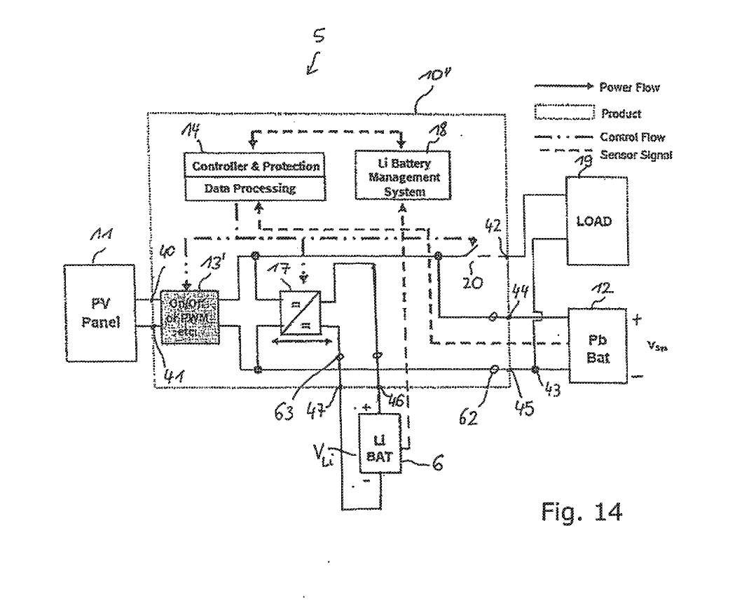

FIGS. 13 and 14 show further embodiments of a hybrid storage system 5, which are similar to the embodiment of FIGS. 1, 2 and 7. According to the embodiments of FIGS. 13 and 14, the batteries 6 and 12 do not form part of the hybrid storage system 5 but are plugged into the hybrid storage system 5.

According to one example, the batteries 6, 12 are provided with voltage sensors and connections for connecting the voltage sensors to the hybrid storage system 10′. According to another example, the hybrid storage system is provided with a lead-acid battery voltage sensor 62 and a lithium battery voltage sensor 63. Furthermore, an input voltage sensor 64 and a supply current sensor 65 may be provided. The sensors, which are symbolized by open circles, can be realized in various ways. For example, the sensors may be connected to two corresponding electric lines or to only one electric line. The current sensor may also be provided as magnetic field sensor.

The embodiment of FIG. 14 is similar to the embodiment of FIG. 13 but, in contrast to the preceding embodiment, the hybrid storage system 10′ comprises only one DC/DC converter 17, which is provided for an adjustment of a voltage at terminals of the lithium battery 6. Instead of the second DC/DC converter 13, and input current adjustment means 13′ is provided, for example a controllable On/Off switch, a controllable pulse width modulation (PWM), an overvoltage protection or others. The current adjustment means may be connected to the charge control system 14 by a control line, as shown in FIG. 13.

In the abovementioned description, details have been provided to describe the embodiments of the present invention. It shall be apparent to one skilled in the art, however, that the embodiments may be practised without such details. For example, there are various circuit arrangements for realizing the components of the hybrid storage system. These circuit arrangements may have additional components or other components with similar functions as those shown in the detailed embodiment. For example, the transistors are shown as n-type unipolar transistors in the embodiments. The skilled person will recognize, however, that the arrangement can also be realized with p-type transistors. Other modifications may arise, for example, from reversing the polarity of the batteries, placing voltage sensors at different locations etc.

Although the above description contains much specificity, these should not be construed as limiting the scope of the embodiments but merely providing illustration of the foreseeable embodiments. Especially, the above stated advantages of the embodiments should not be construed as limiting the scope of the embodiments but merely to explain possible achievements if the described embodiments are put into practice. Thus, the scope of the embodiments should be determined by the claims and their equivalents, rather than by the examples given.

For example, the charge and discharge control system may comprise only one chip or multiple hardware components. The functions of the controller may be realized by hardware, by software or by any combination thereof. The hardware may comprise various electronic components, such as integrated circuits, non-integrated electronic circuits, application specific ICs, memory components such as RAM, ROM, EPROM, EEPROM, FPGAs or others.

The embodiments can also be described with the following lists of elements being organized into items. The respective combinations of features which are disclosed in the item list are regarded as independent subject matter, respectively, that can also be combined with other features of the present invention.
1. Hybrid battery-charging device (10) comprising
   input terminals (40, 41) for connecting a photovoltaic panel,
   first battery connections (44, 45) for connecting a lead-acid battery (12),
   second battery connections (46, 47) for connecting a high-cycle chemical battery (6),
   a two-way DC/DC converter (17), wherein a first set of terminals of the two-way DC/DC converter (17) is connected with the second battery connections (46, 47), and wherein a second set of terminals of the two-way DC/DC converter (17) is connected with the first battery connections (44, 45),
   a charge and discharge control system (14), which is connected to the DC/DC converter (17) via respective control lines,
   output terminals (42, 43) for connecting a load (19), wherein an input to the output terminals is derived from the first battery connections (44, 45).
2. Hybrid battery-charging device (10) according to item 1, further comprising
   a control device (13) which is connected to the charge and discharge control system (14), wherein input terminals of the control device (13) are connected to the input terminals (40, 41), and wherein output terminals of the control device (13) are connected to input terminals of the DC/DC converter (17).
3. Hybrid battery-charging device (10) according to item 2, wherein the control device (13) comprises a pulse width modulation.
4. Hybrid battery-charging device (10) according to item. 2 or item 3, wherein the control device (13) comprises a maximum power point tracker.
5. Hybrid battery-charging device (10) according to item 2 or item 3, wherein the control device (13) comprises a controllable switch (13′).
6. Hybrid battery-charging device (10) according to item 2 or item 3, wherein the control device (13) comprises a DC/DC converter (13′).
7. Hybrid battery-charging device (10) according to one of the preceding items, wherein the two-way DC/DC converter (17) comprises a buck-boost converter, a buck converter, a boost converter or another converter topology.
8. Hybrid battery-charging device (10) according to one of the preceding items, wherein the two-way DC/DC converter (17) comprises at least two semiconductor switches (29, 30), wherein respective input connections of the transistors (29, 30) are connected to the charge and discharge control system (14) via respective control lines.
9. Hybrid battery-charging device (10) according to one of the preceding items, comprising
   first voltage measuring connections for connecting a first voltage sensor, the first voltage sensor being connected to terminals of the lead-acid battery (12) and the first voltage measuring connections being connected to the charge and discharge control system (14),
   second voltage measuring connections for connecting a second voltage sensor, the second voltage sensor being connected to terminals of the high-cycle chemical battery and the second voltage measuring connections being connected to the charge and discharge control system (14).
10. Hybrid battery-charging device (10) according to item 1 or item 2, comprising a separate battery management system for the high-cycle chemical battery, the separate battery management system (18) being connected to the charge and discharge control system (14).
11. Hybrid storage system (5) with a hybrid charging device (10) according to one of the preceding items, further comprising a high-cycle chemical battery (6) which is connected to the second battery connections (46, 47).
12. Hybrid storage system (5) according to item 11, wherein the high-cycle chemical batter (6) comprises a lithium battery (6).
13. Hybrid storage system (5) according to item 11, further comprising a capacitor which is connected in parallel to the high-cycle chemical battery (6).
14. Hybrid storage system (5) according to one of the items 11 to 13, further comprising a lead-acid battery (12), the lead-acid battery (12) being connected to the first battery connections (44, 45).
15. Hybrid storage system (5) according to one of the items 11 to 14, further comprising a
   a first voltage sensor which is connected to a terminal of the first battery (12) and to the charge and discharge control system (14),
   a second voltage sensor which is connected to a terminal of the second voltage battery (6) and to the charge and discharge control system (14).
16. Method for charging a lead-acid battery (12) and a high-cycle chemical battery (6) of a hybrid storage system (5) by an electric power source (11),
   charging the lead-acid battery (12) in a first battery charging phase until the lead-acid battery (12) has reached a first predetermined state of charge,
   charging the lead-acid battery (12) and the high-cycle chemical battery (6) in a topping/boost/equalization phase until the lead-acid battery (12) has reached a second predetermined state of charge,
   charging the high-cycle chemical battery (6) in a third battery charging phase during which an essentially constant system voltage is applied to system terminals of the lead-acid battery (12) and the system voltage is converted, especially up-converted, into a charging voltage at terminals of the high-cycle chemical battery (6).
17. Method according to item 16, the equalization phase further comprising applying a voltage at the lead-acid battery that oscillates between a predetermined lower voltage and a predetermined upper voltage.
18. Method for charging a hybrid storage system (5) according to item 16 or item 17, further comprising maintaining a mean voltage at terminals of the lead-acid battery (12) at an end-of-charge voltage of the lead-acid battery (12) during the equalization phase.
19. Method for charging a hybrid storage system (5) according to one of items 16 to 18, wherein, during the equalization phase, a system voltage at terminals of the lead-acid battery is controlled to be constant such that a charge current to the lead-acid battery decreases and a remaining charging power is transferred to the high-cycle chemical battery (6).
20. Method for charging a hybrid storage system (5) according to one of items 16 to 19, wherein the essentially constant system voltage that is applied to the system terminals during the charging of the high-cycle chemical battery (6) in the third battery charging phase is equal to a maximum open circuit voltage V_Pb_maxOC of the lead-acid battery (12).
21. Method for charging a hybrid storage system (5) according to one of items 16 to 20, wherein a decision for starting the equalization phase and a decision for starting the third battery charging phase is taken depending on a system voltage at terminals of the lead-acid battery.
22. Method for discharging a lead-acid battery (12) and a high-cycle chemical battery (6) of a hybrid storage system (5) the method comprising
   supplying a load (19) with power by discharging a high-cycle chemical battery (6) via system terminals of a lead-acid battery (12) and maintaining the voltage at the system terminals essentially equal to a maximum open circuit voltage of the lead-acid battery (12), until the output voltage of the high-cycle chemical battery (6) has reached an end-of-discharge voltage of the high-cycle chemical battery (6),
   discharging the lead-acid battery (12) until the voltage of the lead-acid battery (12) has reached an end-of-discharge voltage of the lead-acid battery (12).
23. Method according to item 22, wherein the steps of discharging the high-cycle chemical battery (6) and of discharging the lead-acid battery (12) are executed in parallel.
24. Hybrid battery-charging device (10) according to one of items 1 to 8, wherein the charge and discharge control system (14) comprises means for executing the steps of a method according to one of the items 16 to 23.

Furthermore, the embodiments can also be described with the following lists of elements being organized into items. The respective combinations of features which are disclosed in the item list are regarded as independent subject matter, respectively, that can also be combined with other features of the present invention.
1. A hybrid battery-charging device (10) comprising
   input terminals (40, 41) for connecting a photovoltaic panel,
   first battery connections (44, 45) for connecting a lead-acid battery (12),
   second battery connections (46, 47) for connecting a high-cycle chemical battery (6),
   a two-way DC/DC converter (17), wherein a first set of terminals of the two-way DC/DC converter (17) is connected with the second battery connections (46, 47), and wherein a second set of terminals of the two-way DC/DC converter (17) is connected with the first battery connections (44, 45),
   output terminals (42, 43) for connecting a load (19), wherein an input to the output terminals is derived from the first battery connections (44, 45),
   a charge and discharge control system (14, 18), which is connected to the two-way DC/DC converter (17) by a control line, the charge and discharge control system (14, 18) comprising
   a first sensing input for sensing a state of charge of the lead-acid-battery (12) and for sensing an internal resistance of the lead-acid battery (12),
   a second sensing input for sensing a state of charge of the high-cycle chemical battery (6),
   a control output for controlling the two-way DC/DC converter (17),
   a controller unit,
   wherein the controller unit is operative to detect when an internal resistance of the lead-acid battery (12) exceeds a predetermined resistance threshold, the controller unit being further operative to control the two-way DC/DC converter (17), in response to the internal resistance of the lead-acid battery (12) exceeding the predetermined resistance threshold, such that, in a discharge mode, the lead-acid battery (12) and the high-cycle chemical battery (6) are discharged in parallel during a parallel discharge phase.
2. The hybrid battery-charging device (10) according to item 1, wherein the controller unit is operative to select a discharge strategy in response to an input signal to the charge and discharge control system (14, 18), and wherein the discharge strategy comprises conditions for the start and the termination of the parallel discharge phase.
3. The hybrid battery-charging device (10) according to item 2, wherein the controller unit is operative to derive a first battery condition of the lead-acid battery (12) and to derive a second battery condition of the high-cycle chemical battery (6) and to select the discharge strategy based on the first battery condition and on the second battery condition.
4. The hybrid battery-charging device (10) according to any of the items 1 to 3, wherein the controller unit system is operative to start the parallel discharge phase when the charge and discharge control system (14, 18) enters the discharge mode and to terminate the parallel discharge phase when the charge and discharge control system (14, 18) detects that the lead-acid battery (12) has reached a predetermined discharged state of charge.
5. The hybrid battery-charging device (10) according to any of the items 1 to 3, wherein the controller unit is operative to first discharge the high-cycle chemical battery (6) until the high-cycle chemical battery (6) has reached a predetermined state of charge, and to start the parallel discharge phase after (when) the high-cycle chemical battery (6) has reached the predetermined state of charge and to terminate the parallel discharge phase when the lead-acid battery (12) has reached a predetermined discharged state of charge.
6. The hybrid battery-charging device (10) according to any of the items 1 to 3, wherein the controller unit is operative to first discharge the high-cycle chemical battery (6) until the high-cycle chemical battery (6) has reached a first predetermined state of charge, and to discharge the lead-acid battery (12) to a second predetermined state of charge after the high-cycle chemical battery (6) has reached the second predetermined state of charge, and to start the parallel discharge phase after the lead-acid battery (12) has reached the second predetermined state of charge and to terminate the parallel discharge phase when the lead-acid battery (12) has reached a predetermined discharged state of charge.
7. The hybrid battery-charging device (10) according to any of the items 1 to 3, wherein the controller unit is operative to first discharge the lead-acid battery (12) to a predetermined state of charge, to start the parallel discharge phase after the lead-acid battery (12) has reached the predetermined state of charge and to terminate the parallel discharge phase when the lead-acid battery (12) has reached a predetermined discharged state of charge.
8. The hybrid battery-charging device (10) according to any of items 4, 5, 6 or 7, wherein the controller unit is operative to control the control output such that the high-cycle chemical battery (6) reaches a predetermined discharged state of charge essentially at the same time when the lead-acid battery (12) reaches the predetermined discharged state of charge.
9. The hybrid battery-charging device according to any of the preceding items, the hybrid battery-charging device comprising a flooded lead-acid battery that is connected to the first battery connections, wherein the hybrid battery-charging device comprises a concentration sensor for measuring an electrolyte concentration of the flooded lead-acid battery, the concentration sensor being connected to the first sensing input of the charge and discharge control system.
10. The hybrid battery-charging device according to item 9, wherein the concentration sensor comprises one or more optical fibres.
11. The hybrid battery-charging device according to any of the preceding items, the hybrid battery-charging device comprising a dry lead-acid battery that is connected to the first battery connections.
12. The hybrid battery-charging device according to item 11, wherein the dry lead-acid battery comprises an absorptive glass mat lead-acid battery.
13. The hybrid battery-charging device according to item 11, wherein the dry lead-acid battery comprises a gel lead-acid battery.
14. The hybrid battery-charging device according to any of the preceding items, comprising a voltage sensor for measuring an open circuit voltage of the lead-acid battery, the voltage sensor being connected to the first sensing input of the charge and discharge control system, the charge and discharge control system being operative to interrupt a charging or discharging cycle for measuring the open circuit voltage.
15. The hybrid battery-charging device according to any of the preceding items, comprising an external coil for measuring a state of charge, the external coil being placed in proximity to the lead-acid battery and the external coil being connected to the first sensing input of the charge and discharge control system.
16. The hybrid battery-charging device according to any of the preceding items, comprising a resonance circuit for applying an alternating voltage signal to terminals of the lead-acid battery and a voltage sensor for measuring a response signal of the lead-acid battery, the resonance circuit being connected to a control output of the charge and discharge control system and the voltage sensor being connected to the first sensing input of the charge and discharge control system.
17. The hybrid battery-charging device according to any of the preceding items, the lead-acid battery comprising one or more electrodes for measuring an electrochemical noise of the lead-acid battery, the one or more electrodes being connected to the first sensing input of the charge and discharge control system.
18. A method for charging a hybrid battery storage device with a lead-acid battery (12) and a high-cycle chemical battery (6), wherein a two-way DC/DC converter is connected between terminals of the high-cycle chemical battery (6) and terminals of the lead-acid battery (12), comprising
   sensing a state of charge of the lead-acid-battery (12),
   sensing an internal resistance of the lead-acid battery (12),
   sensing a state of charge of the high-cycle chemical battery (6),
   detecting, by evaluating signals from the second sensing input, when an internal resistance of the lead-acid battery (12) exceeds a predetermined resistance threshold, if the lead-acid battery (12) exceeds the predetermined internal resistance threshold
   controlling the two-way DC/DC converter (17), such that, in a discharge mode, the lead-acid battery (12) and the high-cycle chemical battery (6) are discharged in parallel during a parallel discharge phase.
19. The method according to item 18, comprising
   starting the parallel discharge phase after entering into a discharge mode, if it is detected that the lead-acid battery (12) has reached a predetermined discharged state of charge,
   terminating the parallel discharge phase.
20. The method according to item 19, comprising
   deriving a first battery condition of the lead-acid battery (12),
   deriving a second battery condition of the high-cycle chemical battery (6), and
   selecting the discharge strategy based on the first battery condition and on the second battery condition.
21. The method according to any of the items 18 to 20, comprising
   starting the parallel discharge phase when the charge and discharge control system (14) enters the discharge mode,
   terminating the parallel discharge phase when a charge and discharge control system (14) detects that the lead-acid battery (12) has reached a predetermined discharged state of charge.
22. The method according to any of the items 18 to 20, comprising
   first discharging the high-cycle chemical battery (6) until the high-cycle chemical battery (6) has reached a predetermined state of charge, and
   starting the parallel discharge phase after the high-cycle chemical battery (6) has reached the predetermined state of charge and to terminate the parallel discharge phase when the lead-acid battery (12) has reached a predetermined discharged state of charge.
23. The method according to any of the items 18 to 20, comprising
   first discharging the high-cycle chemical battery (6) until the high-cycle chemical battery (6) has reached a first predetermined state of charge,
   discharging the lead-acid battery (12) to a second predetermined state of charge after the high-cycle chemical battery (6) has reached the first predetermined state of charge,
   starting the parallel discharge phase after the lead-acid battery (12) has reached the second predetermined state of charge, and
   terminating the parallel discharge phase when the lead-acid battery (12) has reached a predetermined discharged state of charge.
24. The method according to any of the items 18 to 20, comprising
   first discharging the lead-acid battery (12) to a predetermined state of charge,
   starting the parallel discharge phase after the lead-acid battery (12) has reached the predetermined state of charge, and
   terminating the parallel discharge phase when the lead-acid battery (12) has reached a predetermined discharged state of charge.
25. The method according to any of items 18 to 20, comprising
   controlling the two-way DC/DC converter such that the high-cycle chemical battery (6) reaches a predetermined discharged state of charge essentially at the same time when the lead-acid battery (12) reaches the predetermined discharged state of charge.
26. The method according to any of the items 18 to 25, comprising determining an internal resistance of the lead-acid battery by measuring an electrolyte concentration.
27. The method according to any of the items 18 to 26, comprising determining an internal resistance of the lead-acid battery by measuring an open circuit voltage.
28. The method according to any of the items 18 to 27, comprising determining an internal resistance of the lead-acid battery by measuring an impedance of the lead-acid battery.
29. The method according to item 28, wherein the impedance of the lead-acid battery is determined by measuring a battery resonance frequency.
30. The method according to item 29, wherein the impedance of the lead-acid battery is determined by measuring a variation of the inductance of an external sense coil.

1-30. (canceled)

31. A hybrid battery-charging device, comprising:
input terminals for connecting a photovoltaic panel,
first battery connections for connecting a lead-acid battery;
second battery connections for connecting a high-cycle chemical battery;
a two-way DC/DC converter, wherein a first set of terminals of the two-way DC/DC converter is connected with the second battery connections, and wherein a second set of terminals of the two-way DC/DC converter is connected with the first battery connections;
output terminals for connecting a load, wherein an input to the output terminals is derived from the first battery connections; and
a charge and discharge control system which is connected to the two-way DC/DC converter by a control line, the charge and discharge control system including:
a first sensing input for sensing a state of charge of the lead-acid-battery and for sensing an internal resistance of the lead-acid battery,
a second sensing input for sensing a state of charge of the high-cycle chemical battery,
a control output for controlling the two-way DC/DC converter, and
a controller unit, wherein the controller unit is operative to detect when an internal resistance of the lead-acid battery exceeds a predetermined resistance threshold, the controller unit being further operative to control the two-way DC/DC converter, in response to the internal resistance of the lead-acid battery exceeding the predetermined resistance threshold, such that, in a discharge mode, the lead-acid battery and the high-cycle chemical battery are discharged in parallel during a parallel discharge phase.

32. The hybrid battery-charging device according to claim 31, wherein the controller unit is operative to select a discharge strategy in response to an input signal to the charge and discharge control system, and wherein the discharge strategy comprises conditions for the start and the termination of the parallel discharge phase.

33. The hybrid battery-charging device according to claim 32, wherein the controller unit is operative to derive a first battery condition of the lead-acid battery and to derive a second battery condition of the high-cycle chemical battery and to select the discharge strategy based on the first battery condition and on the second battery condition.

34. The hybrid battery-charging device according to claim 31, wherein the controller unit system is operative to start the parallel discharge phase when the charge and discharge control system enters the discharge mode and to terminate the parallel discharge phase when the charge and discharge control system detects that the lead-acid battery has reached a predetermined discharged state of charge.

35. The hybrid battery-charging device according to claim 31, wherein the controller unit is operative to first discharge the high-cycle chemical battery until the high-cycle chemical battery has reached a predetermined state of charge, and to start the parallel discharge phase after (when) the high-cycle chemical battery has reached the predetermined state of charge and to terminate the parallel discharge phase when the lead-acid battery has reached a predetermined discharged state of charge.

36. The hybrid battery-charging device according to claim 31, wherein the controller unit is operative to first discharge the high-cycle chemical battery until the high-cycle chemical battery has reached a first predetermined state of charge, and to discharge the lead-acid battery to a second predetermined state of charge after the high-cycle chemical battery has reached the second predetermined state of charge, and to start the parallel discharge phase after the lead-acid battery has reached the second predetermined state of charge and to terminate the parallel discharge phase when the lead-acid battery has reached a predetermined discharged state of charge.

37. The hybrid battery-charging device according to claim 31, wherein the controller unit is operative to first discharge the lead-acid battery to a predetermined state of charge, to start the parallel discharge phase after the lead-acid battery has reached the predetermined state of charge and to terminate the parallel discharge phase when the lead-acid battery has reached a predetermined discharged state of charge.

38. The hybrid battery-charging device according to claim 34, wherein the controller unit is operative to control the control output such that the high-cycle chemical battery reaches a predetermined discharged state of charge essentially at the same time when the lead-acid battery reaches the predetermined discharged state of charge.

39. The hybrid battery-charging device according to claim 31, the hybrid battery-charging device comprising a flooded lead-acid battery that is connected to the first battery connections, wherein the hybrid battery-charging device comprises a concentration sensor for measuring an electrolyte concentration of the flooded lead-acid battery, the concentration sensor being connected to the first sensing input of the charge and discharge control system.

40. The hybrid battery-charging device according to claim 39, wherein the concentration sensor comprises one or more optical fibers.

41. The hybrid battery-charging device according to claim 31, the hybrid battery-charging device comprising a dry lead-acid battery that is connected to the first battery connections.

42. The hybrid battery-charging device according to claim 41, wherein the dry lead-acid battery comprises an absorptive glass mat lead-acid battery.

43. The hybrid battery-charging device according to claim 41, wherein the dry lead-acid battery comprises a gel lead-acid battery.

44. The hybrid battery-charging device according to claim 31, comprising a voltage sensor for measuring an open circuit voltage of the lead-acid battery, the voltage sensor being connected to the first sensing input of the charge and discharge control system, the charge and discharge control system being operative to interrupt a charging or discharging cycle for measuring the open circuit voltage.

45. The hybrid battery-charging device according to claim 31, further comprising an external coil for measuring a state of charge, the external coil being placed in proximity to the lead-acid battery and the external coil being connected to the first sensing input of the charge and discharge control system.

46. The hybrid battery-charging device according to claim 31, further comprising a resonance circuit for applying an alternating voltage signal to terminals of the lead-acid battery and a voltage sensor for measuring a response signal of the lead-acid battery, the resonance circuit being connected to a control output of the charge and discharge control system and the voltage sensor being connected to the first sensing input of the charge and discharge control system.

47. The hybrid battery-charging device according to claim 31, wherein the lead-acid battery includes one or more electrodes for measuring an electrochemical noise of the lead-acid battery, the one or more electrodes being connected to the first sensing input of the charge and discharge control system.

48. A method for charging a hybrid battery storage device with a lead-acid battery and a high-cycle chemical battery, wherein a two-way DC/DC converter is connected between terminals of the high-cycle chemical battery and terminals of the lead-acid battery, the method comprising:
sensing a state of charge of the lead-acid-battery;
sensing an internal resistance of the lead-acid battery;
sensing a state of charge of the high-cycle chemical battery;
detecting, by evaluating signals from the second sensing input, when an internal resistance of the lead-acid battery exceeds a predetermined resistance threshold, and
if the lead-acid battery exceeds the predetermined internal resistance threshold, controlling the two-way DC/DC converter, such that, in a discharge mode, the lead-acid battery and the high-cycle chemical battery are discharged in parallel during a parallel discharge phase.

49. The method according to claim 48, further comprising:
starting the parallel discharge phase after entering into a discharge mode; and
if it is detected that the lead-acid battery has reached a predetermined discharged state of charge, terminating the parallel discharge phase.

50. The method according to claim 49, further comprising:
deriving a first battery condition of the lead-acid battery;
deriving a second battery condition of the high-cycle chemical battery; and
selecting the discharge strategy based on the first battery condition and on the second battery condition.

51. The method according to claim 48, further comprising:
starting the parallel discharge phase when the charge and discharge control system enters the discharge mode; and
terminating the parallel discharge phase when a charge and discharge control system detects that the lead-acid battery has reached a predetermined discharged state of charge.

52. The method according to claim 48, further comprising
first discharging the high-cycle chemical battery until the high-cycle chemical battery has reached a predetermined state of charge; and
starting the parallel discharge phase after the high-cycle chemical battery has reached the predetermined state of charge and to terminate the parallel discharge phase when the lead-acid battery has reached a predetermined discharged state of charge.

53. The method according to claim 48, further comprising:
first discharging the high-cycle chemical battery until the high-cycle chemical battery has reached a first predetermined state of charge;
discharging the lead-acid battery to a second predetermined state of charge after the high-cycle chemical battery has reached the first predetermined state of charge;
starting the parallel discharge phase after the lead-acid battery has reached the second predetermined state of charge; and
terminating the parallel discharge phase when the lead-acid battery has reached a predetermined discharged state of charge.

54. The method according to claim 48, further comprising:
first discharging the lead-acid battery to a predetermined state of charge;
starting the parallel discharge phase after the lead-acid battery has reached the predetermined state of charge; and
terminating the parallel discharge phase when the lead-acid battery has reached a predetermined discharged state of charge.

55. The method according to claim 48, further comprising:
controlling the two-way DC/DC converter such that the high-cycle chemical battery reaches a predetermined discharged state of charge essentially at the same time when the lead-acid battery reaches the predetermined discharged state of charge.

56. The method according to claim 48, further comprising:
determining an internal resistance of the lead-acid battery by measuring an electrolyte concentration.

57. The method according to claim 48, further comprising:
determining an internal resistance of the lead-acid battery by measuring an open circuit voltage.

58. The method according to claim 48, further comprising:
determining an internal resistance of the lead-acid battery by measuring an impedance of the lead-acid battery.

59. The method according to claim 58, wherein the impedance of the lead-acid battery is determined by measuring a battery resonance frequency.

60. The method according to claim 59, wherein the impedance of the lead-acid battery is determined by measuring a variation of the inductance of an external sense coil.
